(19) United States
(12) Patent Application Publication
(10) Pub. No.: US 2004/0083311 A1
(43) Pub. Date: Apr. 29, 2004

(54) Signal processing system and method

(76) Inventors: James Zhuge, Palo Alto, CA (US); Zhengge Tang, San Jose, CA (US); Lixin Yu, San Jose, CA (US); Guozhong Shen, San Jose, CA (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/161,655

(22) Filed: Jun. 5, 2002

(51) Int. Cl. G06F 3/00

(52) U.S. Cl. 710/1

(57) ABSTRACT

A signal analysis system is provided that includes master DSP circuitry, slave DSP circuitry, a LVDS bus, wherein the LVDS bus couples the master DSP circuitry to the slave DSP circuitry, and a USB interface, wherein the USB interface is coupled to the master DSP circuit.

### FIELD OF THE INVENTION

The present invention relates generally to data acquisition and signal processing. More particularly, the present invention is directed to a method and apparatus that allows signal data to be throughput to a storage medium during real-time analysis of the signal data.

### BACKGROUND OF THE INVENTION

Scientists and engineers, who desire to monitor or analyze signals, such as noise and vibrations, will often utilize a dynamic signal analyzer that is dedicated to the processing and displaying of analog signals in real-time. The processing of an analog signal typically involves transforming the analog signal from the time domain to frequency domain or other domain utilizing digital processing techniques that employ Fourier Transform or Fast Fourier Transform algorithms and/or various filtering techniques. Upon transformation, the transformed signal is either output to the user interface level for display, for further analysis or for any kind of storage.

It has been found useful to also save the original or raw data before it is subjected to digital signal processing techniques. Thus, it can be accessed at a later time for simply replaying the original/raw signal data or for further processing of the original/raw signal data.

Methods have been developed that allow the signal data to be stored while the data is being processed in real-time. One conventional method involves connecting the test object to both a signal analyzer and a data acquisition system. Thus, when a separate signal analyzer and a data acquisition system is utilized, the user was required to purchase two units of equipment.

Another conventional method involves the use of combination devices that allow a user to analyze the signal data while allowing the data to be stored on an internal storage device. However, storage mediums capable of permanently storing the signal data are high in cost. Thus, the requirement of an internal storage device increases the cost associated with the manufacturing of a combination device.

Accordingly, it would be desirable to provide a dynamic signal analysis system, capable of analyzing signal data in real-time, while allowing throughput of the signal data to a storage medium that is external to the device, that reduces the cost associated with the evaluation of signals.

### SUMMARY OF THE INVENTION

In one aspect of the present invention, a signal analysis system is provided that includes master digital signal processing (DSP) circuitry, slave DSP circuitry, a Low Voltage Differential Signaling (LVDS) bus, wherein the LVDS bus couples the master DSP circuitry to the slave DSP circuitry, and a USB (Universal Serial Bus) interface, wherein the USB interface is coupled to the master DSP circuit.

In another aspect of the present invention, a signal analysis system is provided that includes a means for converting the analog data to digital domain, a means for analyzing the signal data, and a means for throughputting the signal data to an external storage device, wherein the analyzing means and the throughput means operate in parallel.

In another aspect of the present invention, a method for processing data in real-time and storing the data in parallel is provided that includes analyzing and storing signal data in parallel, comprising the steps of A/D conversion of the signal data, processing the signal data, throughputtting the signal data to an external storage device via a USB interface, wherein the processing of the signal data and the throughputting of the signal data are performed in parallel.

In yet another aspect of the present invention, a signal analysis system is provided that includes a master DSP circuit, a plurality of slave DSP circuits, and a LVDS bus configured in a closed loop that couples each of the plurality of slave DSP circuits in series with the master DSP circuits.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a dynamic signal analysis system in accordance with the present invention.

FIG. 2 is a block diagram of a communication system between master digital signal processing circuitry and slave digital signal processing circuitry in accordance with the present invention.

FIG. 3 is a flow chart of a method for processing and storing signal data in parallel in accordance with the present invention.

### DETAILED DESCRIPTION OF PREFERRED EMBODIMENTS OF THE INVENTION

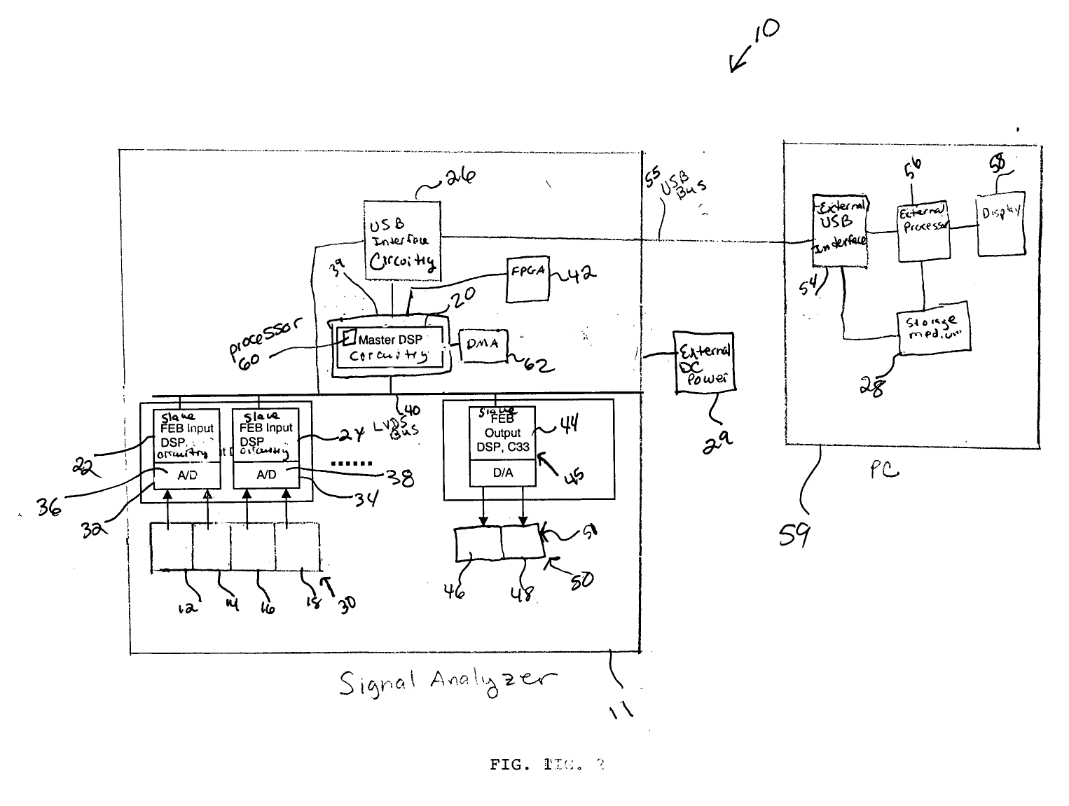

Referring now to FIG. 1 of the figures, wherein like numerals indicate like elements, there is shown in FIG. 1, a signal processing system 10 in accordance with the present invention that allows signal data to be throughput to a storage medium during real-time signal analysis of the signal data. Shown in FIG. 1, an exemplary embodiment of a signal processing system 10, in accordance with the present invention, includes a signal analyzer 11 that integrates input modules 12-18 for signal conditioning, signal processing circuitry, for example, master digital signal processing (DSP) circuitry 20 and slave DSP circuitry 22, 24 for performing real-time signal analysis and Universal System Bus (USB) interface circuitry 26 for accomplishing data acquisition, i.e., allowing the signal data acquired to be throughput to an external storage medium 28. In an exemplary embodiment of the present invention, an external DC power supply 29 is utilized to power the signal analyzer 11.

Each input port 12-18 is utilized to receive a signal at particular frequency bandwidth and particular gain setting (i.e., channel). As shown in FIG. 1, the input ports 12-18 are part of an input module 30. The modular configuration of the input ports 12-18 allows the signal processing system 10 to be easily expanded to accommodate additional inputs 12-18 via the addition of additional input modules 30. Accordingly, a user is not limited to the number of inputs present 12-18 when the signal processing system 10 is acquired. The physical quantities that an input port can measure varies based on different requirement. For example, when the signal analysis system 10 is equipped with different signal conditioning circuitry and different types of transducers, the input ports can measure, for example, acceleration, velocity, displacement, temperature, pressure, sound pressure, rotating speed, number of input pulses.

In an exemplary embodiment of the present invention, each input module 30 has four input ports 12-18. In another exemplary embodiment of the present invention, each input module 30 has two input ports 12-18. Further, an exemplary embodiment of a signal processing system 10, in accordance with the present invention, accommodates up to eight four-input modules 30 or 16 two-input modules. However, it should be understood by one of ordinary skill in the art the number of input ports 12-18, the number of input ports 30 per input module, and the number of input modules 30 may vary.

Slave DSP circuitry, which may be accommodated on a slave DSP board 32, 24, such as a front-end board (FEB), is coupled to an input port 12-18 to perform processing functions known in the art, for example, filtering, triggering, basic Fast Fourier Transform, order tracking, and octave analysis processing functions. In an exemplary embodiment of the present invention, each slave DSP circuit 22, 24 performs processing functions for up to two channels received at the input ports 12-18. However, it should be understood by one of ordinary skill in the art that the slave DSP circuitry 22, 24 may be utilized to process any number of inputs.

In the same or another exemplary embodiment of the present invention, analog-to-digital (A/D) converter circuitry 36, 38 is coupled to the slave DSP circuitry 22,24. In an exemplary embodiment of the present invention, the A/D circuitry 36, 38 resides on the slave DSP board 32, 34 with the slave DSP circuitry 22, 24. The A/D circuitry 36, 38 is utilized to convert an analog signal received at an input port 12-18 to a digital signal for processing by the slave DSP circuitry 22, 24.

The slave DSP circuits 22, 24 and/or slave DSP boards 32, 34 are coupled to the master DSP circuitry 20, which may reside on a master DSP board 39, via low voltage differential signaling (LVDS) 40. LVDS 40 is a bi-directional sixteen-bit bus that utilizes all sixteen bits to transfer data. LVDS is known in the art as a fast way to communicate data between two devices that requires little power, and operates at a speed of one hundred mega bits per second (bps) to greater than one giga bps. In an exemplary embodiment of the present invention, LVDS is running at a speed of 480 mega bps.

An important feature of LVDS 40 is that it allows the slave DSP circuits 22, 24 and/or boards 32, 34 to be serialized. The communication between master DSP 20 and slave DSP circuitry 22, 24 and/or boards 32, 34 is multiplexed. The data is processed and buffered on each slave DSP 22, 24 and/or boards 32, 34 before it is transferred to the master DSP 20. When the data is ready to transfer, the slave DSP 22, 24 send messages to the master DSP through the LVDS serial bus 40 and generate interrupt.

Master DSP 20 will receive the data utilizing a message-driven management software structure of the master DSP circuitry 20 and/or board 39 that allows the master DSP circuitry to read the data of each of the slave DSP circuits 22,24, individually, from the serialized data. By carefully arranging the tasks between master DSP 20 and slave DSP circuitry 22, 24 all the input data can be analyzed in real-time, i.e., without missing data.

Further, a signal processing system 10 in accordance with the present invention does not require each slave DSP circuit 22, 24 and/or board 32, 34 to be individually connected to the master DSP circuitry 20. Thus, a signal processing system 10 in accordance with the present invention requires less conductive connections, such as cables and connectors, to couple the slave DSP circuitry 22, 24 to the master DSP circuitry 20. Accordingly, a signal processing system 10 in accordance with the present invention reduces the cost associated with manufacturing a signal analysis system.

In an exemplary embodiment of the present invention, when the slave DSP circuits 22, 24 are serially connected, the master DSP circuitry 20 receives data from the slave DSP circuits 22, 24 and/or boards 32, 34 in a serialized format. However, the data has to be transformed to a parallel format to accomplish the processing of every channel individually. A field programmable gate array (FPGA) 42, which is known in the art, is utilized to control the communication between the master DSP circuitry 20 and the slave DSP circuitry 22, 24, such that the data of all of the channels is buffered on each slave DSP, transferred in serial to master DSP, and processed accordingly. In an exemplary embodiment of the present invention, the FPGA 42 controls when the master DSP circuitry 20 requests data from the slave DSP circuits 22, 24 and/or boards 32, 34 to achieve the desired processing function.

The output DSP circuitry 44, which may be signal conditioning circuitry, is in charge of generating certain waveform based on the playback signal or a user defined mathematical model, such as a sine wave or a white noise generator. In the case of playback, the data is downloaded from external device to master DSP 20 then output to slave DSP output circuitry 44 that may reside on an output DSP board 45. Slave output ports 46, 48 are coupled to slave DSP output circuitry 44. In an exemplary embodiment of the present invention the slave DSP output circuitry 50 prepares the processed data to be output to an output port 46, 48. In an exemplary embodiment of the present invention, the slave DSP output circuitry 44 performs the processing functions for two outputs 46, 48.

In the same or another exemplary embodiment of the present invention, the two output ports 46, 48 are incorporated into an output module 50. It should be understood by one of ordinary skill in the art that the number of output ports 46, 48 that slave output circuitry 44 services may vary. It should also be understood by one of ordinary skill in the art that the number of output ports 46, 48 per output module 50 and the number of output modules 50 may vary.

In the same or another exemplary embodiment of the present invention, digital-to-analog (D/A) circuitry 51 is utilized to convert the digital signal, resulting from the digital signal processing of the raw signal data, to an analog signal.

The slave DSP circuits 22,24/boards 32,34 are also utilized to pass the raw data, such as signal data in the time domain, to USB interface circuitry 26. USB interface circuitry 26 is provided to communicate the input signal data in a raw or unprocessed format to an external storage medium 28 associated with external USB interface circuitry 54 that is utilized to receive the signal data from the USB interface circuitry 26 of the signal analyzer 11. Accordingly, the signal data can be transmitted over a USB bus 55 to the external storage medium 28 and/or to an external processor 56 that directs the raw data to an external storage medium 28, without requiring the signal analyzer 11 to have an internal storage medium capable of permanently storing the raw data. Accordingly, the cost associated with a signal analysis system 10 in accordance with the present invention is reduced. The “raw data” may include those data after certain time domain processing, such as calibration, high pass or low pass filtering or decimation.

Further, the USB bus 55 allows data acquisition to be accomplished in the parallel with the signal processing operations. In an exemplary embodiment of the present invention a USB 2.0 interface is utilized. The USB 2.0 interface allows a signal analyzer in accordance with the present invention to be utilized with any USB-ready device. Accordingly, the signal analyzer can be connected and reconnected to external devices without having to reconfigure the connection each time.

In the same or another exemplary embodiment of the present invention, the USB interface circuitry 26 is utilized to communicate the raw data and/or processed data to a display 56. In an exemplary embodiment of the present invention, the external USB interface circuitry 54, external storage medium 28, and display 58 are part of a personal computing (PC) 59 device.

In an exemplary embodiment of the present invention, the master DSP circuitry 26 and/or board 39 includes a processor 60 that processes with a direct memory access (DMA) capability 62. The slave DSP circuits 22,24 and/or boards 32,34 communicate the raw data utilizing DMA 62. The processor 60 of the master DSP circuitry 20/board 39 communicates with the slave DSP circuitry 22,24 and/or A/D converter 36,38 to copy the data in its raw format, i.e., before certain processing and/or the transforming functions are performed on the signal data.

In an exemplary embodiment of the present invention, the processor 60 of the master DSP circuitry 20/board 39 directs the unprocessed/raw data, utilizing DMA 62, to the USB interface. In the same or another exemplary embodiment of the present invention, the processor 60 of the master DSP 20 executes instructions that provide for the copying and/or communicating of data from the slave DSP circuits 22,24,44 to the memory associated with the master DSP 20. In an exemplary embodiment of the present invention, the data in the memory associated with the master DSP is copied/and or communicated, according to instructions executed by the master DSP, to the USB interface circuitry where it is communicated over a USB bus 55 to, for example, an external storage medium 28.

In another exemplary embodiment of the present invention, the data in memory associated with any of the DSP processing circuits 20,22,24,44 is communicated to the USB interface circuitry for transmission to an external device, upon request for the raw data from an external processor 56, for example, a CPU of a PC device 59, the external device 56, 58,28,59. In an exemplary embodiment of the present invention, the external device is allowed to have a copy of the raw data stored in any of the DSP circuits 20,22,24,44 and/or boards 32,34,39,45. In an exemplary embodiment of present invention, the external processor 56 directs the raw data received to a storage medium 28 that is associated with the external processor 56.

The memory on processor 60 does not permanently store the raw data. Accordingly, the costs associated with are less than the cost of more permanent storage mediums. Thus, the costs of manufacturing a signal analyzer 11 in accordance with the present invention is less than the costs of manufacturing a conventional signal analyzer that requires a separate data acquisition device or a combination system that requires costly permanent storage mediums to collect and store the raw data.

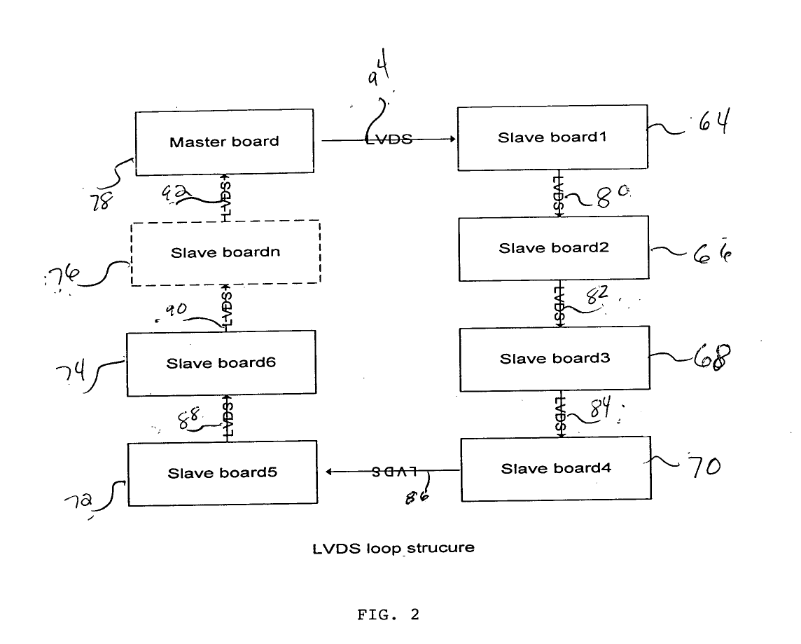

In an exemplary embodiment of the present invention, as shown in FIG. 2, one through n slave DSP boards 64-76 are serially connected in a circular loop/transmission path to a master DSP board 78 via LVDS 80-94. Data can be transferred between the master DSP board 78 and each slave DSP 64-76 board individually, by instructing the LVDS 80-94 on how to treat each slave DSP board 64-76 in the loop. The master DSP board 78 and each of the slave DSP boards 64-76 can be in either a send, receive or bypass mode. Thus, for example, if the master DSP board 78 wants to send data to slave DSP board 76, slave DSP boards 64-74 would be treated as in a bypass mode, master DSP board 78 would be treated as in a send mode and slave DSP board 76 would be treated as in a receive mode. If any of the front-end boards 32, 34,45, i.e., either an input board or an output board, is not installed physically, a relay module will be inserted to fill the blank position. Thus the circular loop topology can always guaranteed. The relay module is always conceived as a by-pass function.

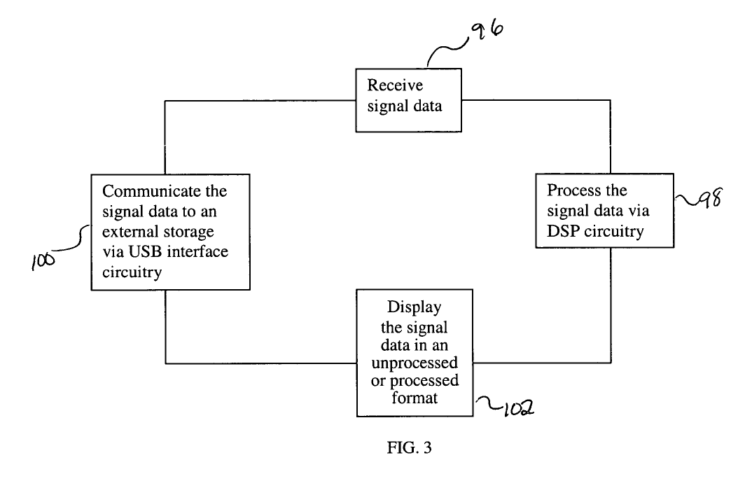

FIG. 3 is a flow chart illustrating a method of processing and storing data in parallel. In step 96, the signal analyzer of the signal analysis system 10 receives the signal data. In steps 98 and 100 the signal analysis system processes the signal data via the DSP circuitry 20,22,24 and, in parallel, communicates the raw signal data via USB interface circuitry 26 to an external storage medium. In step 102, the signal analysis system 10 outputs the unprocessed signal data and/or processed signal to a display.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

It is understood that the invention is not confined to the particular construction and arrangement of parts herein illustrated and described, but embraces all such modified forms thereof as come within the scope of the following claims.

What is claimed is:

1. A signal analysis system, comprising:
master DSP circuitry;
slave DSP circuitry;
an LVDS bus that couples the master DSP circuitry to the slave DSP circuitry; and
a USB interface coupled to the master DSP circuitry.

2. The signal analysis system of claim 1, further comprising an input port coupled to the slave DSP circuitry.

3. The signal analysis system of claim 2, further comprising an A/D converter coupled to the slave DSP circuitry.

4. The signal analysis system of claim 1, further comprising:
output DSP circuitry coupled to the master DSP circuitry; and
an output port coupled to the output DSP circuitry.

5. The signal analysis system of claim 4, further comprising a D/A converter coupled to the output DSP circuitry.

6. The signal analysis system of claim 1, further comprising two input ports coupled to the slave DSP circuitry, said two input ports being incorporated into a two-input module.

7. The signal analysis system of claim 1, further comprising four input ports coupled to the slave DSP circuitry, said four input ports being incorporated into a four-input module.

8. The signal analysis system of claim 6, further comprising two outputs ports coupled to the slave DSP circuitry, said two output ports being incorporated into a two-output module that is interchangeable with the two-input module.

9. The signal analyzer of claim 7, further comprising two output ports coupled to the slave DSP circuitry, said two output ports being incorporated into a two-output module that is interchangeable with the four-input module.

10. The signal analyzer of claim 1, wherein the USB interface is a USB 2.0 interface.

11. The signal analyzer of claim 6, wherein sixteen two-input modules are coupled to the slave DSP circuitry.

12. The signal analyzer of claim 7, wherein the signal analyzer accommodates eight four-input modules.

13. The signal analysis system of claim 1, wherein the slave DSP circuitry comprises at least two slave DSP circuits that are serially connected via the LVDS bus.

14. The signal analysis system of claim 1, further comprising a DMA coupled to the master DSP circuitry that transfers raw data communicated from the slave DSP circuitry.

15. The signal analysis system of claim 14, further comprising an external storage medium coupled to the memory buffer that receives the raw data stored in the memory buffer via the USB interface.

16. A signal analysis system, comprising:
means for receiving signal data;
means for analyzing the signal data; and
means for throughputting the signal data to an external storage device, wherein the analyzing means and the throughput means operate in parallel.

17. The signal analysis system of claim 16, wherein the throughputting means is a USB 2.0 interface.

18. The signal analysis system of claim 16, wherein the analyzing means comprises master DSP circuitry and slave DSP circuitry.

19. The signal analysis system of claim 18, further comprises a means for serially communicating data between the master DSP circuitry and the slave DSP circuitry.

20. The signal analysis system of claim 19, wherein the communicating means is an LVDS bus.

21. A method for analyzing and storing signal data in parallel, comprising the steps of:
receiving signal data;
processing the signal data; and
throughputting the signal data to an external storage device via a USB interface, wherein the processing of the signal data and the throughputting of the signal data are performed in parallel.

22. A signal analysis system, comprising:
a master DSP circuit;
a plurality of slave DSP circuits; and
an LVDS bus configured in a closed loop that couples each of the plurality of slave DSP circuits in series with the master DSP circuit.
